(19) United States
(12) Patent Application Publication
(10) Pub. No.: US 2009/0141850 A1
(43) Pub. Date: Jun. 4, 2009

(54) PRESSURIZED WATER REACTOR PRESSURIZER HEATER SHEATH

(75) Inventor: Christopher L. Hoffmann, West Granby, CT (US)

Correspondence Address: WESTINGHOUSE ELECTRIC COMPANY, LLC, P.O. BOX 355, PITTSBURGH, PA, 15230-0355, US

(73) Assignee: Westinghouse Electric Company, LLC, Monroeville, PA (US)

(21) Appl. No.: 12/323,540

(22) Filed: Nov. 26, 2008

Related U.S. Application Data
(60) Provisional application No. 60/992,153, filed on Dec. 4, 2007.

(51) Int. Cl. G21C 1/09; G21C 1/08

(52) U.S. Cl. 376/307; 976/DIG. 2

(57) ABSTRACT

A pressurizer whose heater sheaths are conditioned to reduce the residual stresses resulting from cold working during manufacture. After material conditioning, the heater sheath undergoes a surface conditioning treatment to add outer surface compressive stresses.

### CROSS REFERENCE TO RELATED APPLICATIONS

This application claims priority to Provisional Application Ser. No. 60/992,153, filed Dec. 4, 2007.

### BACKGROUND OF THE INVENTION

1. Field of the Invention

This invention pertains generally to pressurized water reactor systems and more particularly to a pressurizer heater employed in such systems.

2. Description of the Prior Art

The primary side of nuclear reactor power generating systems which are cooled with water under pressure, comprises a closed circuit which is isolated and in heat exchange relationship with a secondary side for the production of useful energy. The primary side comprises the reactor vessel enclosing a core internal structure that supports a plurality of fuel assemblies containing fissile material, the primary circuit within heat exchange steam generators, the inner volume of a pressurizer, pumps and pipes for circulating pressurized water; the pipes connecting each of the steam generators and pumps to the reactor vessel independently. Each of the parts of the primary side comprising a steam generator, a pump and a system of pipes which are connected to the vessel form a loop of the primary side.

For the purpose of illustration, FIG. 1 shows a simplified nuclear reactor primary system, including a generally cylindrical reactor pressure vessel 10 having a closure head 12 enclosing a nuclear core 14. A liquid reactor coolant, such as water is pumped into the vessel 10 by pump 16 through the core 14 where heat energy is absorbed and is discharged to a heat exchanger 18, typically referred to as a steam generator, in which heat is transferred to a utilization circuit (not shown), such as a steam driven turbine generator. The reactor coolant is then returned to the pump 16, completing the primary loop. At least one of the loops is also connected to a pressurizer pump 22 for maintaining the pressure of the system. Typically, a plurality of the above described loops are connected to a single reactor vessel 10 by the reactor coolant piping 20.

As a result of the harsh environment findings experienced in a pressurized water reactor system the pressure vessels, their welds and the components within the pressure vessels may degrade as a result of micro-cracking otherwise known as stress corrosion cracking, or other degradation/failure mechanisms during plant operation and/or plant transient conditions. Depending upon time, temperature, pressure and the corrosive nature of the contained fluid, which is borated water, these degradations may eventually develop into pathways through which fluids may leak from the pressure vessels or their internal components may fail. Thus, for example, after decades of operation at temperatures of up to approximately 600° Fahrenheit (316° Celsius) or more and pressures of up to 2200 PSI (15.2 MPa) or more, indications of cracking have been detected in the course of non-destructive examinations of pressure vessels in light water nuclear reactor systems designed to generate commercial electric power. In some cases, small leaks have been detected in the sleeves extending through the heads of pressure vessels such as in the sleeves that carry the powers cables through the pressure vessel walls of the pressurizers, that are employed to energize the resistance heaters used for raising the pressure within the pressurized water reactor system. In addition, resistance heater failures have been noted due to stress corrosion cracking of their sheaths that are designed to isolate the resistance heaters from the surrounding coolant in the pressurizer pressure vessels. patent application Ser. No. 11/075,494 filed Mar. 9, 2005 and published as U.S. Patent Application Publication 2005/0199591 addresses the repair of the sleeves in a manner that will minimize the potential for further leaks in the area. It is desirable to also provide an improved heater design that will minimize the potential for heater sheath failures due to stress corrosion cracking in the future to avoid the need for additional repairs and personnel exposure to radiation.

Accordingly, it is an objective of this invention to provide a pressurizer heater for a pressurized water reactor system that has an improved operating life.

### SUMMARY OF THE INVENTION

This invention achieves the foregoing objectives by replacing the pressurizer heater sheaths with sheaths that have received a material conditioning treatment to reduce residual stresses that were originally introduced after cold working (swaging) during manufacture, followed by a surface conditioning treatment that adds outer surface compression stresses to the region of the sheath adjacent its outer surface.

In one preferred embodiment, both material conditioning and surface conditioning treatments may be applied to existing heater sheaths during servicing of the pressurizer, to spare heater sheaths that are maintained in inventory or to newly manufactured sheaths, such that crack initiation is less likely to occur over extended plant operation. The preferred method for material conditioning is a heat treatment. The surface conditioning applied after heat treatment is preferably a method such as centerless burnishing or shot peening. In addition, laser peening may also be employed for the surface conditioning step.

### BRIEF DESCRIPTION OF THE DRAWINGS

A further understanding of the invention can be gained from the following description of the preferred embodiments when read in conjunction with the accompanying drawings in which:

FIG. 1 is a simplified schematic of a nuclear reactor system to which this invention can be applied;

FIG. 2 is an elevational view, partially in section, showing a pressurizer made in the coordinates of this invention;

FIG. 3 is a partial sectional view of a heating element for the pressurizer of FIG. 2; and

FIG. 4 is a schematic view of a material conditioning and surface conditioning treatment.

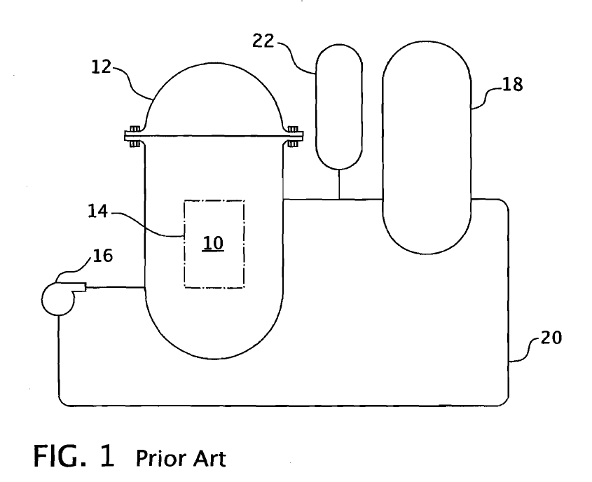

### DESCRIPTION OF THE PREFERRED EMBODIMENTS

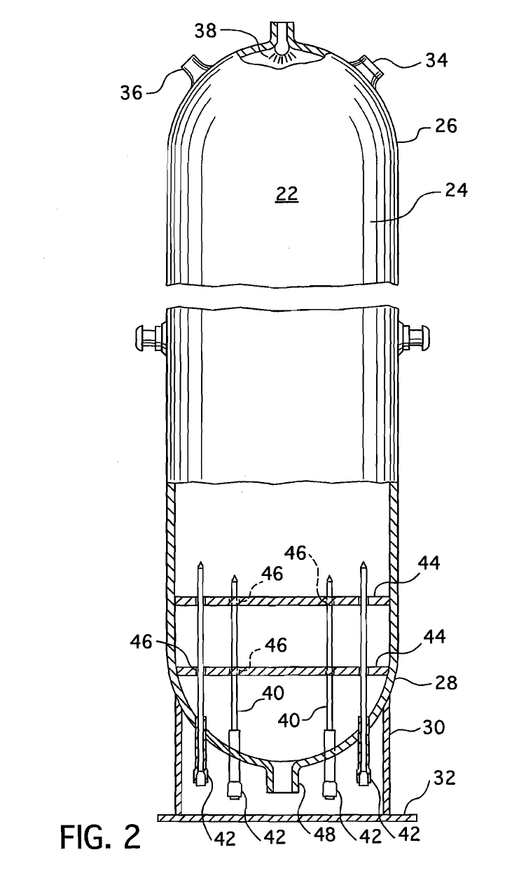

Referring again to the drawings, FIG. 2 shows a pressurizer 22 for a pressurized water reactor nuclear power plant system. The pressurizer 22 comprises a vessel having a vertically oriented cylindrical shell portion 24, a first or upper hemispherical head portion 26 and a second or lower hemispherical head portion 28. A cylindrical skirt 30 extends downwardly from the lower head portion 28 and has a flange 32 fastened thereto by welding or other means to form a support structure for the vessel. The upper head portion 26 has a manway 34, one or more nozzles 36 in fluid communication with safety valves (not shown) and a spray nozzle 38 disclosed therein. The spray nozzle 38 is in fluid communication with a supply of relatively cool fluid and has means cooperatively associated therewith (not shown), which controls the flow of the relatively cool fluid to the pressurizer 22.

A plurality of straight tubular electrical immersion resistance heating elements 40 are vertically disposed in the lower head portion 28 of the vessel. Lower head 28 has a plurality of nozzles 42, which have an enlarged end and which receive the heating elements 40. A seal is formed between the tubular heating elements 40 and the nozzles 42 by welding or other sealing means.

To support the heating elements 40, a plurality of support plates 44 are disposed transversely in the lower portion of the vessel. These support sheets or plates 44 have a plurality of holes 46 which receive the heating elements 40. The holes 46 and the adjacent support plates are aligned with the nozzles 42.

A combination inlet and outlet nozzle 48 is centrally disposed in the lower head 28 and places the pressurizer 22 in fluid communication with the primary fluid of the pressurized water reactor nuclear power plant system.

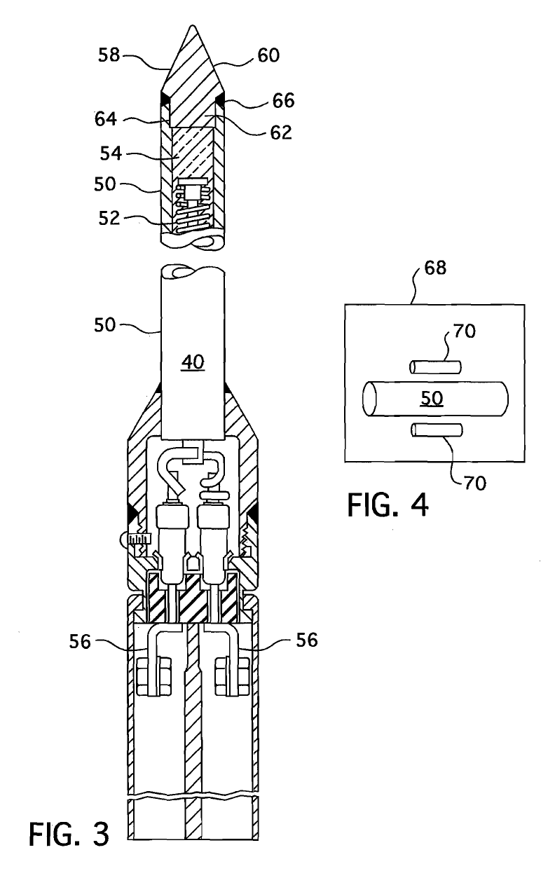

As shown in FIG. 3, the tubular immersion heating element 40 have a tubular metallic sheath 50 and a resistance heating coil 52 disposed within the sheath 50 and separated therefrom by dielectrically insulating material 54.

Two electrical leads 56 are brought out at one end, at the back end, of the heating element 40. As shown in FIG. 3, the back end of the heating element 40 has heavy walls and is expanded outwardly forming a bulbous end. The leads 56 are electrically connected to an electrical supply (not shown), which when energized results in the coils becoming resistantly heated. Another end of the heating element 40, the front or nose end, has a pointed nose portion 58. The pointed nose portion 58 comprises a conical portion 60 having a base diameter generally equal to the outside diameter of the sheath 50 and a cylindrical portion 62, smaller in diameter than the base of the conical portion 60. The sheath 50 has a counter-bore 64 which receives the cylindrical portion 62 of the nose portion 58. A seal weld 66 is provided between the sheath 50 and the base of the conical portion 60. The pointed nose portion 58, shown in FIG. 3, allows the heaters to be replaced, when they burn out, without having someone inside the vessel, which is slightly radioactive, even though the openings 46 in the support plates 44 and the nozzles 42 are slightly misaligned, thus reducing the amount of radiation to which maintenance people are subjected during the replacement procedure. Thus, it should be understood that the pointed nose portion 58 is an optional feature to facilitate maintenance.

The operation of the pressurizer 22 is as follows; normally the pressurizer 22 is partially filled with primary fluid or water, the remainder of the vessel 22 is filled with steam; the combined inlet and outlet nozzles 48 is in fluid communication with the primary fluid in the pressurized water reactor system; and to increase the pressure of the primary fluid the heating elements 40 are energized thereby causing the water to boil and increase the amount of vapor in the pressurizer 22 to increase the pressure in the primary fluid system; to reduce the pressure of the primary fluid system, relatively cold primary fluid is sprayed though the spray nozzles 38 in the upper portion of the pressurizer 22 condensing some of the steam and thereby reducing the pressure within the pressurizer and in the primary fluid system.

As previously noted, stress corrosion cracks have been found in the heater sheaths 50 compromising the interior of the heater elements 40 resulting in premature failure. In accordance with one embodiment of this invention both material conditioning and surface conditioning treatments are applied to the heater sheath 50 to reduce residual stresses in the heater sheath 50 such that crack initiation is less likely to occur. The preferred method for material conditioning is a heat treatment, figurally illustrated in FIG. 4 which shows a heated sheath 50 being treated in a furnace 68. The heat treatment is preferably at a temperature between 1800 and 1900° F. (980 and 1040° C.) for a period of from 5 to 15 minutes. The surface conditioning is preferably a centerless burnishing treatment, as figuratively indicated by the rollers 70 in FIG. 4, or shot peening. Alternatively, laser peening may be employed during the surface conditioning step to impart compressive forces to the outer surface of the sheath 50. These steps may also be employed on existing heaters during periodic maintenance of the pressurizer 22, or on spare heaters that are maintained in inventory and can be exchanged with the existing heaters during such periodic maintenance. Most preferably, new replacement heaters will be manufactured with this process.

While specific embodiments of the invention have been described in detail, it will appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A pressurizer for a pressurized water reactor system including a heater sheath produced by a process including the steps of:
reducing cold working stresses in the sheath; and
generating compressive stresses in the sheath's outer surface after the residual cold working stresses are substantially reduced in the sheath.

2. The pressurizer of claim 1, wherein the residual cold working stresses are reduced in a conditioning treatment.

3. The pressurizer of claim 1, wherein the residual cold working stresses are reduced in a heat treatment.

4. The pressurizer of claim 1, wherein compressive stresses in the surface of the heater sheath are generated by a centerless burnishing method.

5. The pressurizer of claim 1, wherein compressive stresses in the surface of the heater sheath are generated by a shot peening process.

6. The pressurizer of claim 1, wherein compressive stresses in the surface of the heater sheath are generated by a laser peening process.

7. A pressurized water reactor system pressurizer heater including a heater sheath produced by a process including the steps of:
reducing cold working stresses in the sheath; and
generating compressive stresses in the sheath's outer surface after the residual cold working stresses are substantially reduced in the sheath.

8. The heater sheath of claim 7, wherein the residual cold working stresses are reduced in a conditioning treatment.

9. The heater sheath of claim 7, wherein the residual cold working stresses are reduced in a heat treatment.

10. The heater sheath of claim 7, wherein compressive stresses in the surface of the heater sheath are generated by a centerless burnishing method.

11. The heater sheath of claim 7, wherein compressive stresses in the surface of the heater sheath are generated by a shot peening process.

12. The heater sheath of claim 7, wherein compressive stresses in the surface of the heater sheath are generated by a laser peening process.

13. A pressurized nuclear reactor power system including a pressurizer having a heater comprising a heater sheath produced by a process including the steps of:
reducing cold working stresses in the sheath; and
generating compressive stresses in the sheath's outer surface after the residual cold working stresses are substantially reduced in the sheath.

14. The pressurized nuclear reactor power system of claim 13, wherein the residual cold working stresses are reduced in a conditioning treatment.

15. The pressurized nuclear reactor power system of claim 13, wherein the residual cold working stresses are reduced in a heat treatment.

16. The pressurized nuclear reactor power system of claim 13, wherein compressive stresses in the surface of the heater sheath are generated by a centerless burnishing method.

17. The pressurized nuclear reactor power system of claim 13, wherein compressive stresses in the surface of the heater sheath are generated by a shot peening process.

18. The pressurized nuclear reactor power system of claim 13, wherein compressive stresses in the surface of the heater sheath are generated by a laser peening process.
